(19) United States
(12) Patent Application Publication
(10) Pub. No.: US 2002/0062247 A1
(43) Pub. Date: May 23, 2002

(54) Selecting web site content to be displayed to a web site visitor based upon a probability distribution

(76) Inventor: Bradley P. Allen, Manhattan Beach, CA (US)

Correspondence Address: PARK, VAUGHAN & FLEMING LLP, 508 SECOND STREET, SUITE 201, DAVIS, CA, 95616, US

(21) Appl. No.: 09/874,948

(22) Filed: Jun. 4, 2001

Related U.S. Application Data
(60) Provisional application No. 60/228,845, filed on Aug. 29, 2000.

(51) Int. Cl. G06F 17/60

(52) U.S. Cl. 705/14; 705/10

(57) ABSTRACT

One embodiment of the present invention provides a system dynamically selects a content option from a plurality of content options in order to display the content option to a user who is browsing through a web site. The system operates by receiving a request for content from a web browser that is being operated by the user. In response to this request, the system calculates a probability distribution across the plurality of content options that can be sent to the web browser, and then selects the content option at random from the plurality of content options based upon the calculated probability distribution. Next, the system sends the selected content option to the web browser and then allows the web browser to display the selected content option to the user of the web browser. The system then receives a response to the selected content option from the user of the web browser, and uses this response to update a future probability distribution across the plurality of content options.

### RELATED APPLICATION

This application hereby claims priority under 35 U.S.C. §119 to U. S. Provisional Patent Application No. 60/228,845 filed Aug. 29, 2000, entitled, “Selecting Web Site Content To Be Displayed to a Web Site Visitor Based upon a Probability Distribution” by inventor Bradley P. Allen.

### BACKGROUND

1. Field of the Invention

The present invention relates to dynamically selecting content to be displayed to a web site visitor. More specifically, the present invention relates to a method and an apparatus for dynamically selecting content to be displayed to a web site visitor based on a probability distribution.

2. Related Art

The tremendous growth of electronic commerce has led to an explosion in the number of web sites offering products and services for sale. Unlike conventional methods for propagating sales messages, which typically rely on mass media to distribute a uniform message to thousands or millions of consumers, electronic commerce makes it possible to tailor the presentation of a message on a web site to the individual tastes of a specific consumer based upon information previously gathered about the consumer.

To this end, web sites have been “personalized” so that the interests displayed by a consumer in clicking through various regions of a web site and making purchases, as well as other demographic information provided by the consumer, can be used to predict the interests of the consumer. These predicted interests are used to tailor the presentation of a sales message to an individual consumer in order to maximize the probability of a sale. These predicted interests can also be used to filter out material that is not of interest to the consumer.

Existing personalization systems select web site content to be presented to a consumer based upon relatively naive classification mechanisms that simply select the content based upon the historic likelihood that the content will produce a desired response, such as causing the consumer to purchase an item. These existing classification mechanisms do not attempt to optimize expected payoff in making a selection over a number of repeated interactions with one or more consumers. Furthermore, these existing mechanisms make no effort to empirically explore response rates for all possible content selections. This makes it hard for existing mechanisms to adapt to changing response rates for content options.

What is needed is a method and an apparatus for selecting web site content to be displayed to a consumer based upon expected payoff of a selection, and that provides a mechanism for empirically monitoring changing response rates for content selection options.

### SUMMARY

One embodiment of the present invention provides a system dynamically selects a content option from a plurality of content options in order to display the content option to a user who is browsing through a web site. The system operates by receiving a request for content from a web browser that is being operated by the user. In response to this request, the system calculates a probability distribution across the plurality of content options that can be sent to the web browser, and then selects the content option at random from the plurality of content options based upon the calculated probability distribution. Next, the system sends the selected content option to the web browser and then allows the web browser to display the selected content option to the user of the web browser. The system then receives a response to the selected content option from the user of the web browser, and uses this response to update a future probability distribution across the plurality of content options. This future probability distribution is used in making a future selection of a content option.

In one embodiment of the present invention, the system uses a multiplicative update function to update the future probability distribution.

In one embodiment of the present invention, in calculating the probability distribution the system substantially optimizes an expected payoff of a selection from the user in response to the selected content option.

In one embodiment of the present invention, the system calculates the probability distribution based upon a customer profile related to the user.

In one embodiment of the present invention, the system calculates the probability distribution based upon an interaction context related to the web site.

In one embodiment of the present invention, the system calculates the probability distribution by combining probability distributions from a plurality of automated experts that provide different probability distributions. In a variation on this embodiment, updating the future probability distribution involves updating a plurality of weights associated with the plurality of automated experts.

In one embodiment of the present invention, in calculating the probability distribution, the system provides a non-zero probability for every content option so that feedback will eventually be generated for every content option.

In one embodiment of the present invention, the plurality of content options include purchase options, links to other web locations, links to other web pages, and promotional material for products.

In one embodiment of the present invention, the system calculates the probability distribution and selects the content option by executing program code that is structured to play a repeated two-player game in which the user of the web browser is an adversary that responds to selected content options.

One embodiment of the present invention provides a system that dynamically selects a content option from a plurality of content options in order to display the content option to a user who is browsing through a web site. The system operates by receiving a request for content from a web browser that is being operated by the user. In response to the request, the system uses a plurality of different selection mechanisms to select a plurality of selected content options from the plurality of content options. Next, the system selects the content option from the plurality of selected content options, and sends the content option to the web browser. The system then allows the web browser to display the content option to the user of the web browser.

In one embodiment of the present invention, selecting the content option from the plurality of selected content options involves using a precedence ordering for the plurality of different selection mechanisms in selecting the content option.

In one embodiment of the present invention, one of the selection mechanisms selects a content option based upon preferences explicitly stated by the user.

In one embodiment of the present invention, one of the selection mechanisms selects a content option based upon prior purchasing behavior of the user.

In one embodiment of the present invention, one of the selection mechanisms selects a content option based upon optimizing an expected payoff from the user in response to the content option.

In one embodiment of the present invention, one of the selection mechanisms selects a content option based prior browsing behavior of the user.

In one embodiment of the present invention, at least one of the selection mechanisms uses a measured system load in selecting the content option, so that when the measured system load is high, the system consumes less system resources in selecting the content option.

In one embodiment of the present invention, at least one of the selection mechanisms uses customer profile information in selecting a content option.

In one embodiment of the present invention, at least one of the selection mechanisms uses interaction context information in selecting a content option.

### BRIEF DESCRIPTION OF THE FIGURES

FIG. 1 illustrates a distributed computing system in accordance with an embodiment of the present invention.

FIG. 2 illustrates a modular architecture for a content option selector in accordance with an embodiment of the present invention.

FIG. 3 illustrates an object structure that facilitates selection of a content option by casting the selection in the framework of a repeated play two-player game in accordance with an embodiment of the present invention.

FIG. 4 is a flow chart illustrating how the content selector architecture from FIG. 2 operates in accordance with an embodiment of the present invention.

FIG. 5 is a flow chart illustrating how a content option is selected in order to optimize an expected payoff in accordance with an embodiment of the present invention.

FIG. 6 is a flow chart illustrating how multiple experts are used in selecting a content option in accordance with an embodiment of the present invention.

FIG. 7 is a flow chart illustrating how expert gains are updated in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital video discs), and computer instruction signals embodied in a transmission medium (with or without a carrier wave upon which the signals are modulated). For example, the transmission medium may include a communications network, such as the Internet.

Distributed Computing System

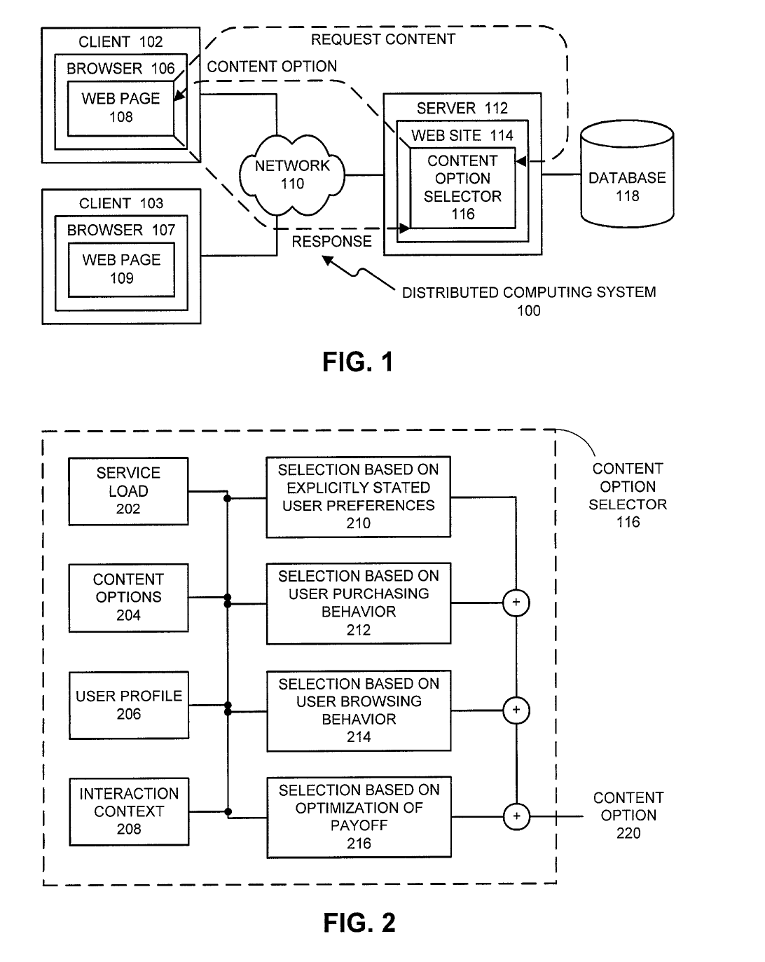

FIG. 1 illustrates a distributed computing system 100 in accordance with an embodiment of the present invention. Distributed computing system 100 includes clients 102-103, which are coupled to server 112 through network 110.

Clients 102-103 can include any node on a network 110 including computational capability and including a mechanism for communicating across network 110.

Clients 102-103 contain browsers 106-107, respectively. Browsers 106-107 can include any type of web browser capable of viewing a web site, such the INTERNET EXPLORER™ browser distributed by the Microsoft Corporation of Redmond, Wash. Note that although the present invention is described in terms of a browser, the present invention can generally apply to any client interface in any device, such as a computer system, a cell phone, a personal digital assistant (PDA) or a computational engine inside of an appliance. Browsers 106-107 display web pages 108-109, respectively. Note that browser 106 is operated by user 101.

Server 112 can include any computational node including a mechanism for servicing requests from clients 102-103 for computational and/or data storage resources. Server 113 includes web site 114, which contains inter-linked pages of textual and graphical information that can be displayed to user 101 through browser 106. Web site 114 includes content option selector 116, which dynamically selects content to be displayed to user 101 through browser 106.

Server 112 is coupled to database 118, which is used to store content and other information for web site 114. Database 118 can include any type of system for storing data in non-volatile storage. This includes, but is not limited to, systems that use magnetic, optical, and magneto-optical storage devices, as well as storage devices based on flash memory and/or battery-backed up memory.

Network 110 can include any type of wire or wireless communication channel capable of coupling together computing nodes. This includes, but is not limited to, a local area network, a wide area network, or a combination of networks. In one embodiment of the present invention, network 110 includes the Internet.

During operation, the system illustrated in FIG. 1 operates generally as follows. While user 101 is accessing web site 114 through browser 106, browser 106 requests content (for example, a web page) from web site 114. In response to this request, content option selector 116 within web site 114 selects a content option. This content option is sent to browser 106, where it is displayed in web page 108 to user 101. User 101 responds in some way to the selected content option, for example by purchasing a product or by clicking on a link to go to another web site. This response is sent back to web site 114. Within web site 114, the response is used to select and update data used by content option selector 116 in selecting additional content.

Modular Architecture for Content Selector

FIG. 2 illustrates a modular architecture for content option selector 116 (from FIG. 1) in accordance with an embodiment of the present invention.

Content option selector 116 takes in a number of inputs, including service load 202, content options 204, user profile 206 and interaction context 208. Service load 202 includes measured load on server 112. This information can be used to decide how much computational time to expend in selecting a content option to display to user 101. If server 112 is heavily loaded, content option selector 116 can use methods that require less computational resources, but are perhaps less optimal. Conversely, when server 112 is less loaded, content option selector 116 can use methods that require more computational resources, but do a better job in selecting a content option.

Content options 204 include a list of content items that can be displayed to user 101. This can include promotional material for products, information on current promotions, purchase options, links to other web locations, and links to other web pages. Note that content options can include text and images as well as active scripts that can be run within browser 106 to perform some type of action for user 101.

User profile 206 includes information related to a current user, such as user 101 from FIG. 1. This may include demographic and psycho-graphic information for user 101, as well as a previous history of interactions with user 101.

Interaction context 208 can include any contextual information related to the current interaction between user 101, browser 106 and web site 114. For example, interaction context 208 can include an identifier for a current web page 108 that user 101 is viewing, session history information for user 101 within web site 114, the current time or any other contextual information.

Content option selector 116 includes a number of different selection mechanisms, including a first selection mechanism 210 that makes selections based upon explicitly stated preferences of user 101. For example, user 101 may specify that user 101 would like to see promotions for golfing products, and selection mechanism 210 will select promotional material based upon this selection.

Content option selector 116 includes a second selection mechanism 212 that makes selections based on prior purchasing behavior of user 101. For example, if user 101 has historically purchased high-priced premium products, selection mechanism 210 will select content options that display high-priced premium products.

Content option selector 116 includes a third selection mechanism 214 that makes selections based on prior browsing behavior of user 101. For example, if user 101 has historically clicked on links relating to sports and sports-related products, selection mechanism 212 will select content options that display links relating to sports and sports-related products.

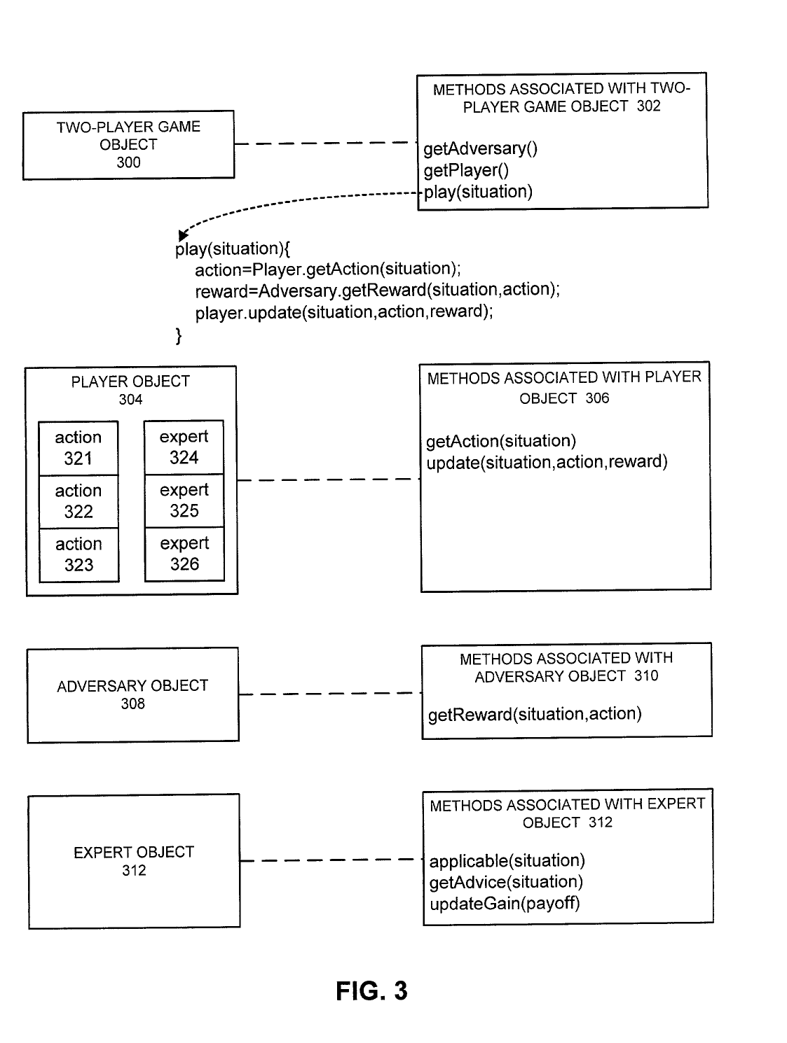

Finally, content option selector 116 includes a fourth selection mechanism 216 that makes selections based optimizing an expected payoff over a number of repeated trials for displaying a content option. This operation of this fourth selection mechanism is described in more detail below with reference to FIGS. 3-7.

Note that in one embodiment of the present invention, selection mechanisms 212 and 214 are based upon an on-line predictive memory. Within an on-line predictive memory, learning takes place during a sequence of trials in which a data record is presented to a learning mechanism, whose goal is to accurately predict whether or not the given data record has a specific property. The learning mechanism makes a prediction about whether the data record has the property, and then receives feedback about whether the prediction was correct. This feedback is used to update a model that the learner uses to make subsequent predictions.

The outputs of selection mechanisms 210, 212, 214 and 216 are combined to produce a final content option 220. In one embodiment of the present invention, content option 220 is selected from the outputs of selection mechanisms 210, 212, 214 and 216 by using a precedence ordering of selection mechanisms 210, 212, 214 and 216. Hence, the output of the first selection mechanism 210 takes precedence over an output of the second selection mechanism 212, which takes precedence over an output of the third selection mechanism 214, which takes precedence over an output of the fourth selection mechanism 216. However, note that in general, any mechanism for selecting between the outputs of selection mechanisms 210, 212, 214 and 216 can be used with the present invention.

Object Structure

FIG. 3 illustrates an object structure that facilitates selection of a content option by casting the selection in the framework of a repeated play two-player game in accordance with an embodiment of the present invention. In this embodiment, the framework is used to implement selection mechanism 216 from FIG. 2, which performs selections based on optimization of expected payoff.

FIG. 3 illustrates four objects, including two-player game object 300, player object 304, adversary object 308 and expert object 312. Two-player game object 300 is associated with a two-player game. A number of methods 302 are associated with two-player game object 300, including getAdversary( ), getplayer( ) and play(situation). The method getAdversary( ) initiates contact with a user 101 who is browsing through a web site 114. The method getPlayer( ) initiates contact with a mechanism that automatically makes selections of content options to be displayed to user 101. In one embodiment of the present invention, this player is a computer program.

The method play(situation) plays the two-player game by repeatedly: getting an action from the player in response to a situation; getting a reward from the adversary in response to the action and the situation; and then updating the selection process used by the player in response to the reward, the action and the situation.

Player object 304 facilitates making selections of content options to be displayed to user 101. Player object 304 is associated with a set of available actions 321-323 that the player can select from. In the context of the present invention, these actions include content options to be presented to user 101 through browser 106. Player object 304 is also associated with a number of experts 324-326, which are different decision-making mechanisms that the player uses in selecting an action. A number of methods 306 are associated with player object 304, including getAction(situation) and update(situation, action, reward). The method getAction(situation) selects an action from the set of available actions based on the situation. The method update(situation, action, reward) updates the decision-making process used by the player in making future selections of actions based upon the situation, the action and the reward.

Adversary object 308 is associated with user 101. A number of methods 306 are associated with adversary object 308, including getReward(situation, action). The method getReward(situation, action) returns a response of user 101 to the action (content option) selected by the player. For example, if the action is an offer for sale, the response can be a purchase transaction.

Expert object 312 is associated with an expert who helps the player in the process of making selections of actions (content options). For example, one expert 324 may make decisions based upon the behavior of users who have displayed an interest in golf, whereas another expert 325 may make decisions based upon the observed behavior of users at different times of the day. A number of methods 314 are associated with expert object 312 including applicable(situation), getAdvice(situation) and updateGain(payoff). The method applicable(situation) returns a boolean value indicating whether the particular expert is applicable for the situation. For example, an expert 324 who makes decisions based upon the behavior of users who have displayed an interest in golf may not be applicable to user who has not displayed an interest in golf. The method getAdvice(situation) returns a probability distribution for the different possible actions 321-324 based on the situation. The method updateGain(payoff) updates the gain for a particular expert based upon a payoff that results from a response of the adversary.

Operation of Modular Content Selector

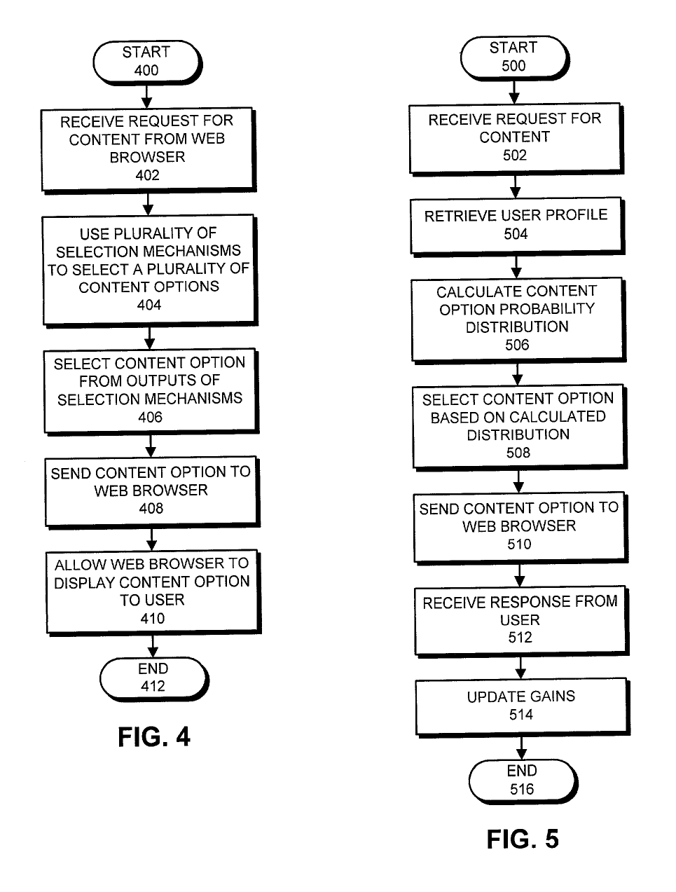

FIG. 4 is a flow chart illustrating how the content option selector architecture from FIG. 2 operates in accordance with an embodiment of the present invention. The system starts by receiving a request for content from web browser 106 (step 402). Next, the system uses a plurality of different selection mechanisms 210, 212, 214 and 216 to select a plurality of content options (step 404). As illustrated in FIG. 2, these selection mechanisms 210, 212, 214 and 216 take in as inputs, service load 202, content options 204, user profile 206 and interaction context 208.

The system then selects content option 220 from the outputs of the selection mechanisms (step 406), and then sends content option 220 to web browser 106 (step 408).

Next, the system allows browser 106 to display content option 220 to user 101 (step 410). As mentioned above, one embodiment of the present invention selects content option 220 by using a precedence ordering of selection mechanisms 210, 212, 214 and 216. However, in general, any mechanism for selecting between the outputs of selection mechanisms 210, 212, 214 and 216 can be used with the present invention.

Process of Selecting Content Option

FIG. 5 is a flow chart illustrating how a content option is selected in order to optimize an expected payoff in accordance with an embodiment of the present invention. FIG. 5 illustrates in more detail to operation of selection mechanism 216 from FIG. 2, which makes a selection based on optimizing an expected payoff.

The system starts by receiving a request for content from browser 106 (step 502). Next, the system optionally retrieves user profile 206 (step 504). In one embodiment of the present invention, user profile 206 is retrieved from database 118 illustrated in FIG. 1. Note that module 216 can operate without user profile 206 because it can make selections based on the predicted behavior of all users.

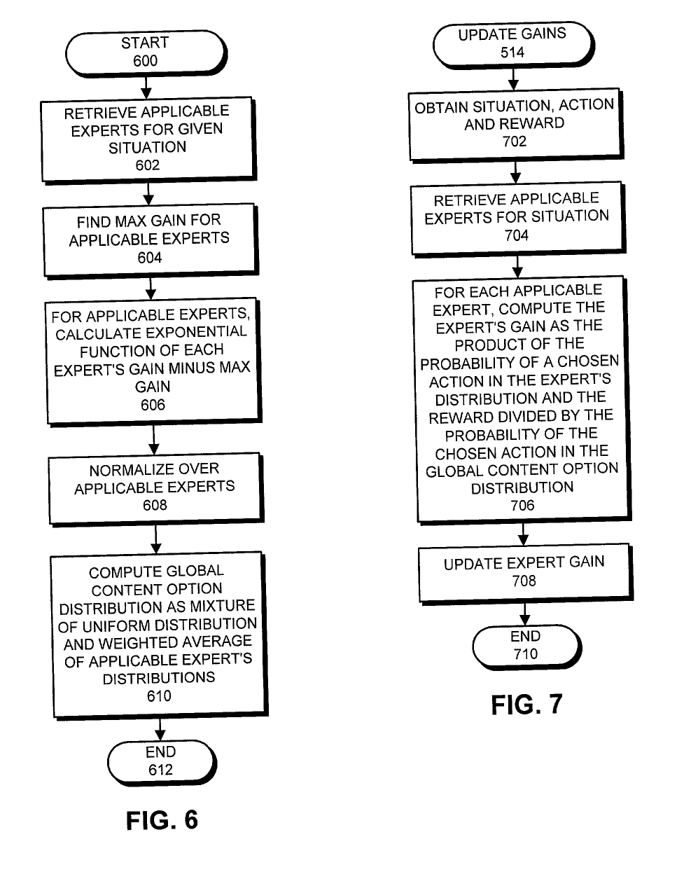

Next, the system calculates a probability distribution for all the possible content options that can be displayed to user 101 (step 506). This probability distribution assigns a probability to each of the possible content options and is described in more detail below with reference to FIG. 6.

The system then randomly selects a content option based on the calculated probability distribution so that a content option with a higher probability is more likely to be selected than a content option with a lower probability (step 508). The system then sends the selected content option to browser 106 (step 510).

After a period of time, the system receives a response from user 101 (step 512). For example, this response may include a purchase transaction, a selection of a link to another web site, or no response. The system uses this response to update gains associated with experts that are involved in calculating the probability distribution (step 514). This updating process is described in more detail below with reference to FIG. 7.

Using Multiple Experts to Select Content Option

FIG. 6 is a flow chart illustrating how multiple experts are used in selecting a content option in accordance with an embodiment of the present invention. The system starts by retrieving the applicable experts for a given situation (step 602). This is accomplished by using the method applicable(situation), which is illustrated in FIG. 3. Next, the system finds a maximum possible gain value across the applicable experts (step 604). Note that each expert and each action has an associated gain value, which is used to weight the contribution of the expert or the action to the probability distribution.

For each applicable expert, the system calculates an exponential function of the expert's gain minus the maximum possible gain value (step 606). This quantity is normalized across all applicable experts (step 608). For example, for a specific action, the gain will be:

$$G ( action ) = \frac{EXP ( Z * ( G ( action ) - Gmax )}{{\sum }_{over all experts} ( EXP ( Z * ( G ( action ) - Gmax ) )}$$

where Z is a gain parameter.

Next, the system computes a global content option distribution as a mixture of the uniform distribution and a weighted average of the applicable expert's distributions (step 610). This uniform distribution is mixed in to ensure that all possible actions are periodically explored. This makes it possible to keep track of the changing responses to actions over time.

Process of Updating Expert Gains

FIG. 7 is a flow chart illustrating how expert gains are updated in accordance with an embodiment of the present invention. The system starts by obtaining a situation, an action and a reward for the action (step 702).

Next, the system retrieves applicable experts for the situation (step 704). For each applicable expert, the system computes the expert's new gain as a product of the probability of the chosen action in the expert's distribution and the resulting reward. This product is divided by the probability of the action in the chosen action in the global content option distribution (step 706). In this way, the expert's gain is increased if the expert assigned a higher probability to the chosen action than the probability of the chosen action in the global content option distribution. More specifically,

$$G ( expert ) = \frac{P ( chosen action in expert ' s distribution ) * reward}{P ( \begin{matrix}chosen action in weighted avg . \\ of all expert ' s distributions\end{matrix} )}$$

This new gain is used to update the expert's gain (step 708).

The foregoing descriptions of embodiments of the invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for dynamically selecting a content option from a plurality of content options in order to display the content option to a user who is browsing through a web site, comprising:
receiving a request for content from a web browser that is being operated by the user;
calculating a probability distribution across the plurality of content options that can be sent to the web browser;
selecting the content option at random from the plurality of content options based upon the calculated probability distribution;
sending the selected content option to the web browser;
allowing the web browser to display the selected content option to the user of the web browser;
receiving a response to the selected content option from the user of the web browser; and
using the response to update a future probability distribution across the plurality of content options that is used in making a future selection of a content option.

2. The method of claim 1, wherein using the response to update the future probability distribution across the plurality of content options includes using a multiplicative update function to update the future probability distribution.

3. The method of claim 1, wherein calculating the probability distribution across the plurality of content options includes calculating the probability distribution by substantially optimizing an expected payoff of a selection by the user in response to the selected content option.

4. The method of claim 1, wherein calculating the probability distribution across the plurality of content options includes calculating the probability distribution based upon a customer profile related to the user.

5. The method of claim 1, wherein calculating the probability distribution across the plurality of content options includes calculating the probability distribution based upon an interaction context related to the web site.

6. The method of claim 1, wherein calculating the probability distribution across the plurality of content options includes combining probability distributions from a plurality of automated experts that provide different probability distributions.

7. The method of claim 6, wherein updating the future probability distribution involves updating a plurality of weights associated with the plurality of automated experts.

8. The method of claim 1, wherein calculating the probability distribution includes providing a non-zero probability for every content option in the plurality of content options so that feedback will eventually be generated for every content option.

9. The method of claim 1, wherein the plurality of content options include purchase options, links to other web locations, links to other web pages, and promotional material for products.

10. The method of claim 1, wherein calculating the probability distribution and selecting the content option involve executing program code that is structured to play a repeated two-player game in which the user of the web browser is an adversary that responds to selected content options.

11. A computer-readable storage medium storing instructions that when executed by a computer cause the computer to perform a method for dynamically selecting a content option from a plurality of content options in order to display the content option to a user who is browsing through a web site, the method comprising:
receiving a request for content from a web browser that is being operated by the user;
calculating a probability distribution across the plurality of content options that can be sent to the web browser;
selecting the content option at random from the plurality of content options based upon the calculated probability distribution;
sending the selected content option to the web browser;
allowing the web browser to display the selected content option to the user of the web browser;
receiving a response to the selected content option from the user of the web browser; and
using the response to update a future probability distribution across the plurality of content options that is used in making a future selection of a content option.

12. The computer-readable storage medium of claim 11, wherein using the response to update the future probability distribution across the plurality of content options includes using a multiplicative update function to update the future probability distribution.

13. The computer-readable storage medium of claim 11, wherein calculating the probability distribution across the plurality of content options includes calculating the probability distribution by substantially optimizing an expected payoff of a selection by the user in response to the selected content option.

14. The computer-readable storage medium of claim 11, wherein calculating the probability distribution across the plurality of content options includes calculating the probability distribution based upon a customer profile related to the user.

15. The computer-readable storage medium of claim 11, wherein calculating the probability distribution across the plurality of content options includes calculating the probability distribution based upon an interaction context related to the web site.

16. The computer-readable storage medium of claim 11, wherein calculating the probability distribution across the plurality of content options includes combining probability distributions from a plurality of automated experts that provide different probability distributions.

17. The computer-readable storage medium of claim 16, wherein updating the future probability distribution involves updating a plurality of weights associated with the plurality of automated experts.

18. The computer-readable storage medium of claim 11, wherein calculating the probability distribution includes providing a non-zero probability for every content option in the plurality of content options so that feedback will eventually be generated for every content option.

19. The computer-readable storage medium of claim 11, wherein the plurality of content options include purchase options, links to other web locations, links to other web pages, and promotional material for products.

20. The computer-readable storage medium of claim 11, wherein calculating the probability distribution and selecting the content option involve executing program code that is structured to play a repeated two-player game in which the user of the web browser is an adversary that responds to selected content options.

21. An apparatus that dynamically selects a content option from a plurality of content options in order to display the content option to a user who is browsing through a web site, comprising:
a receiving mechanism that is configured to receive a request for content from a web browser that is being operated by the user;
a calculating mechanism that is configured to calculate a probability distribution across the plurality of content options that can be sent to the web browser;
a selection mechanism that is configured to select the content option at random from the plurality of content options based upon the calculated probability distribution;
a sending mechanism that is configured to send the selected content option to the web browser;
wherein the receiving mechanism is additionally configured to receive a response to the selected content option from the user of the web browser; and
an updating mechanism that is configured to use the response to update a future probability distribution across the plurality of content options that is used in making a future selection of a content option.

22. The apparatus of claim 21, wherein the updating mechanism is configured to use a multiplicative update function to update the future probability distribution.

23. The apparatus of claim 21, wherein the calculating mechanism is configured to calculate the probability distribution by substantially optimizing an expected payoff of a selection by the user in response to the selected content option.

24. The apparatus of claim 21, wherein the calculating mechanism is configured to calculate the probability distribution based upon a customer profile related to the user.

25. The apparatus of claim 21, wherein the calculating mechanism is configured to calculate the probability distribution based upon an interaction context related to the web site.

26. The apparatus of claim 21, wherein the calculating mechanism is configured to combine probability distributions from a plurality of automated experts that provide different probability distributions.

27. The apparatus of claim 26, wherein the updating mechanism is configured to update a plurality of weights associated with the plurality of automated experts.

28. The apparatus of claim 21, wherein the calculating mechanism is configured to provide a non-zero probability for every content option in the plurality of content options so that feedback will eventually be generated for every content option.

29. The apparatus of claim 21, wherein the plurality of content options include purchase options, links to other web locations, links to other web pages, and promotional material for products.

30. The apparatus of claim 21, wherein the calculating mechanism and the selection mechanism a re configured to play a repeated two-player game in which the user of the web browser is an adversary that responds to selected content options.
